(19) United States
(12) Patent Application Publication
(10) Pub. No.: US 2012/0124981 A1
(43) Pub. Date: May 24, 2012

(54) AXIAL-PISTON ENGINE, METHOD FOR OPERATING AN AXIAL-PISTON ENGINE, AND METHOD FOR PRODUCING A HEAT EXCHANGER OF AN AXIAL-PISTON ENGINE

(75) Inventors: Ulrich Rohs, Dueren (DE); Dieter Voigt, Aachen (DE)

(73) Assignee: GETAS Gesellschaft fuer thermodynamische Antriebssysteme mbH, Dueren (DE)

(21) Appl. No.: 13/386,579

(22) PCT Filed: Jul. 26, 2010
(86) PCT No.: PCT/DE2010/000873

§ 371 Date: Jan. 23, 2012

(30) Foreign Application Priority Data
Jul. 24, 2009 (DE) 10 2009 034 735.6

(51) Int. Cl. F02M 53/02; B23P 15/26; F01N 5/02

(52) U.S. Cl. 60/320; 29/890.03

(57) ABSTRACT

The aim of the invention is to improve the efficiency of an axial-piston motor comprising a fuel supply and an exhaust gas outlet that are coupled in a heat-exchanging manner. To this end, the axial-piston motor is provided with at least two heat exchangers.

The invention relates to an axial-piston engine. The invention also relates to a method for operating an axial-piston engine and to a method for producing a heat exchanger of an axial-piston engine.

Axial-piston engines are sufficiently known from the state of the art, and are characterized as energy-converting machines, which provide mechanical rotational energy on the output side with the aid of at least one piston, whereby the piston executes a linear oscillatory motion whose orientation is aligned essentially coaxially with the axis of rotation of the rotational energy.

In addition to axial piston engines that are operated, for example, only with compressed air, axial-piston engines to which a combustible fuel is supplied are also known. This combustible fuel can be made up of a plurality of components, for example a fuel and air, whereby the components are fed, together or separately, to one or more combustion chambers.

In the present case, the term “combustible fuel” thus designates any material that participates in the combustion, or is carried with components that participate in the combustion, and which flows through the axial-piston engine. The combustible fuel then includes at least a combustible substance or fuel, whereby the term “fuel” in the present context describes any material that reacts exothermally by way of a chemical reaction or other reaction, in particular by way of a redox reaction. In addition, the combustible fuel can also have components such as air, for example, which provide materials for the reaction of the fuel.

In particular, axial-piston engines can also be operated under the principle of internal continuous combustion (icc), according to which combustible fuels, i.e., for example fuel and air, are fed continuously to a combustion chamber or to a plurality of combustion chambers.

Moreover, axial-piston engines can work on the one hand with rotating pistons, and correspondingly rotating cylinders, which are moved successively past a combustion chamber.

On the other hand, axial-piston engines can have stationary cylinders, whereby the working medium is then successively distributed to the cylinders according to the desired loading sequence.

For example, ice axial-piston engines having stationary cylinders of this sort are known from EP 1 035 310 A2 and from WO 2009/062473 A2, whereby in EP 1 035 310 A2 an axial-piston engine is disclosed in which the supplying of combustible fuel and the removal of exhaust gas are coupled with one another with heat transfer.

Axial-piston engines disclosed in EP 1 035 310 A2 and in WO 2009/062473 A2 have in addition a separation between working cylinders and the corresponding working pistons, and compressor cylinders and the corresponding compressor pistons, whereby the compressor cylinders are provided on the side of the axial-piston engine facing away from the working cylinders. In this respect, a compressor side and a working side can be assigned to such axial-piston engines.

It is understood that that the terms “working cylinder,” “working piston” and “working side” are used synonymously with the terms “expansion cylinder,” “expansion piston” and “expansion side” or “expander cylinder,” “expander piston” and “expander side,” as well as synonymously with the terms “expansion stage” or “expander stage,” whereby an “expander stage” or “expansion stage” designates the totality of all “expansion cylinders” or “expander cylinders” located therein.

The task of the present invention is to improve the efficiency of an axial-piston engine.

This task is accomplished by an axial-piston engine with a combustible fuel supply system and an exhaust gas removal system that are coupled with one another with heat transfer, which axial-piston engine is characterized by at least two heat exchangers.

Although two heat exchangers initially lead to a greater expense and more complex flow conditions, the use of two heat exchangers makes possible significantly shorter paths to the heat exchanger and a more favorable energy arrangement of the latter. This surprisingly allows the efficiency of the axial-piston engine to be increased significantly.

This is true in particular for axial-piston engines with stationary cylinders, in which the pistons are always working, in contrast to axial-piston engines in which the cylinders, and therefore also the pistons, also rotate around the axis of rotation, since the latter arrangement needs only one exhaust gas line, past which the cylinders are moved.

Preferably, the heat exchangers are positioned essentially axially, whereby the term “axially” in the present context designates a direction parallel to the main axis of rotation of the axial-piston engine, or parallel to the axis of rotation of the rotational energy. This allows an especially compact and therefore energy-saving design, which is also true in particular if only one heat exchanger is used, but especially if an insulated heat exchanger is used, as described and claimed below.

If the axial-piston engine has at least four pistons, then it is advantageous if the exhaust gases from at least two adjacent pistons are conducted into one heat exchanger, in each instance. In this way, the paths between piston and heat exchanger for the exhaust gases can be minimized, so that losses in the form of waste heat that cannot be recovered by way of the heat exchangers can be reduced to a minimum.

The latter can even be achieved if the exhaust gases from three adjacent pistons are conducted into one common heat exchanger, in each instance.

On the other hand, it is also conceivable that the axial-piston engine comprises at least two pistons, whereby the exhaust gases from each piston are conducted into a heat exchanger of their own. In this respect, it can be advantageous—depending on the concrete implementation of the present invention—if a heat exchanger is provided for each piston. It is true that this leads to an increased construction expense; but on the other hand, the heat exchangers can each be smaller, and therefore possibly of simpler construction, whereby the axial-piston engine as a whole is built more compactly and thus is subject to smaller losses. In particular with this design, but also if a heat exchanger is provided for every two pistons, the particular heat exchanger can—if necessary—be integrated into the spandrel between two pistons, whereby the entire axial-piston engine can be designed correspondingly compactly.

This task of the present invention is accomplished, cumulatively or alternatively to the other features of the present invention, by an axial-piston engine with a combustible fuel supply system and an exhaust gas removal system that are coupled with one another with heat transfer, which axial-piston engine is characterized by at least one heat exchanger insulation system. In this way it is possible to ensure that as much thermal energy as possible remains in the axial-piston engine and is transferred back to the combustible fuel by way of the heat exchangers.

In this connection, it is understood that the heat exchanger insulation does not necessarily have to completely surround the heat exchangers, since some waste heat can possibly also be used advantageously at a different location in the axial-piston engine. However, the heat exchanger insulation should be provided in particular toward the outside.

Preferably, the heat exchanger insulation is designed so that it leaves a maximum temperature gradient between the heat exchanger and the surroundings of the axial-piston engine of 400° C., in particular of at least 380° C. In particular as the transfer of heat progresses, i.e., toward the compressor side, the temperature gradient can then quickly become significantly smaller. Cumulatively or alternatively to this, the heat exchanger insulation can preferably be designed so that the exterior temperature of the axial-piston engine in the area of the heat exchanger insulation does not exceed 500° C. or 480° C. In this way it is ensured that the quantity of energy lost through thermal radiation and thermal conduction is reduced to a minimum, since the losses rise disproportionately at even higher temperatures or temperature gradients. Furthermore, the maximum temperature or maximum temperature gradient occurs only at a small location, since otherwise the temperature of the heat exchanger decreases more and more toward the compressor side.

Preferably, the heat exchanger insulation comprises at least one component made of material that differs from the heat exchanger. This material can then be designed optimally for its task as insulation, and can comprise for example asbestos, asbestos substitute, water, exhaust gas or air, wherein the heat exchanger insulation should have a housing in the case of fluid insulation materials, in particular in order to minimize heat removal through material movement, while in the case of solid insulation materials a housing can be provided for stabilization or as protection. In particular, the housing can be formed from the same material as the jacket material of the heat exchanger.

The task mentioned at the beginning is also accomplished by a method for producing a heat exchanger of an axial-piston engine which has a compressor stage comprising at least one cylinder, an expander stage comprising at least one cylinder and at least one combustion chamber between the compressor stage and the expander stage, wherein the heat-absorbing part of the heat exchanger is situated between the compressor stage and the combustion chamber and the heat-emitting part of the heat exchanger is situated between the expander stage and an environment, wherein the heat exchanger includes at least one pipe wall dividing the heat-emitting part from the heat-absorbing part of the heat exchanger to separate two streams of material, and wherein the production process is characterized by the fact that the pipe is situated in at least one matrix consisting of a material corresponding to the pipe, and connected materially and/or frictionally to this matrix.

The use of a heat exchanger in an axial-piston engine described above can lead to disadvantages through the occurrence of especially high temperature differences between the input and between the output of the heat exchanger on the one hand and between the heat-absorbing and heat-emitting part of the heat exchanger on the other hand, due to damage to the material that limits the service life. In order to counter thermal stresses that result from this and losses of combustible fuel or exhaust gas that occur due to damage, with appropriate design, according to the proposal described above, a heat exchanger can be produced advantageously almost exclusively of only one material at its points that are subject to a critical stress. Even if the latter is not the case, material stresses are advantageously reduced through the solution described above.

It is understood that a solder or other means used for attaching or mounting the heat exchanger can consist of a different material, in particular if the areas involved do not have a high thermal load or a high demand for sealing.

The use of two or more materials with the same thermal expansion coefficient is also conceivable, whereby the occurrence of thermal stresses in the material can be countered in similar manner.

To construct a material and/or frictional connection between the pipe and the matrix, a method for production of a heat exchanger is also proposed which is characterized by the fact that the material connection between the pipe and the matrix is made by welding or soldering. The seal tightness of a heat exchanger is ensured in a simple manner and especially advantageously by a method of this sort. In this case it is again also possible to use a material corresponding to the pipe or to the matrix as the welding or soldering material.

Alternatively or cumulatively to this, the frictional bond between the pipe and the matrix can also be accomplished by shrinking. This in turn has the advantage that thermal stresses between the pipe and the matrix can be prevented, since the use of a material that is different from the material of the pipe or of the matrix, for example, in a materially bonded connection, is avoided. The corresponding connection can then also be provided quickly and operationally reliably.

The task of the invention is also accomplished by an axial-piston engine with at least one compressor cylinder, with at least one working cylinder and with at least one pressure line through which compressed combustible fuel is conducted from the compressor cylinder to the working cylinder, which is characterized by a combustible fuel reservoir in which compressed medium can be stored temporarily.

Increased power can be called for, particularly briefly, through such a combustible fuel reservoir, without a correspondingly increased quantity of combustible fuel first having to be provided by means of the compressors. This is of advantage in particular if the compressor pistons of the compressor are directly connected to working pistons, since an increase in combustible fuel, which can otherwise ultimately be achieved only by an increase in fuel, can then be supplied merely by increased work output. In this respect, fuel can already be saved thereby.

The combustible fuel stored in the combustible fuel reservoir can also be used for example for starting procedures of the axial-piston engine.

Preferably, the combustible fuel reservoir is provided between the compressor cylinder and a heat exchanger, so that the combustible fuel, in particular air provided for the combustion, is temporarily stored in the combustible fuel reservoir still cold, or without yet having extracted energy from the heat exchanger. This has a positive effect on the energy balance of the axial-piston engine, as can be seen directly.

It is advantageous, in particular for longer service life, if a valve is situated between the compressor cylinder and the combustible fuel reservoir, and/or between the combustible fuel reservoir and the working cylinder. In this way, the danger of leakage can be minimized. In particular, it is of advantage if the combustible fuel reservoir can be separated from the pressure line via a valve, or from the assemblies that carry combustible fuel during normal operation, by means of a valve. In this way, the combustible fuel can be stored in the combustible fuel reservoir free of influence from the other operating conditions of the axial-piston engine.

Furthermore, it is also advantageous, independent of the other features of the present invention, if the pressure line between the compressor cylinder and the working cylinder has a valve, so that the supplying of combustible fuel from the combustible fuel reservoir can be stopped operationally reliably, in particular in situations in which no combustible fuel is needed, as is the case for example when stopped at a traffic light or during braking procedures, even if compressed combustible fuel is still being made available by the compressor because of a motion of the axial-piston engine. In particular, a corresponding interruption can then be carried out and the combustible fuel made available by the compressor can immediately go directly into the combustible fuel reservoir, in order to then be available immediately and without delay for example for driving off and acceleration processes.

It is understood in this connection that—depending on the concrete embodiment of the axial-piston engine—a plurality of pressure lines can also be provided, which can be appropriately blocked or connected to a combustible fuel reservoir, individually or together.

A very advantageous design variant provides at least two such combustible fuel reservoirs, whereby differing operating states of the axial-piston engine can be regulated with even greater differentiation.

If the at least two combustible fuel reservoirs are charged with different pressures, operating conditions within the combustion chamber can be influenced especially quickly, without needing for example to allow for delays due to an inherent response behavior of regulating valves. In particular, it is possible that the charging times for the reservoirs can be minimized, and in particular that combustible fuel can be stored already even at low pressures, while at the same time another reservoir is present that contains combustible fuel under high pressure.

Especially varied and intertwined regulating options can accordingly be achieved, if there is a pressure regulating system that defines a first lower pressure limit and a first upper pressure limit for the first combustible fuel reservoir, and a second lower pressure limit and a second upper pressure limit for the second combustible fuel reservoir, within which a combustible fuel reservoir is pressurized, wherein the first upper pressure limit is preferably lower than the second upper pressure limit and the first lower pressure limit is preferably lower than the second lower pressure limit. In particular, the combustible fuel reservoirs used can be operated at different pressure intervals, whereby the energy provided by the axial-piston engine in the form of combustible fuel pressure can be used even more effectively.

In order to be able to realize for example an especially rapid response behavior in the axial-piston engine, in particular with regard to a very broad spectrum of work, it is advantageous if the first upper pressure limit is lower than or equal to the second lower pressure limit. By means of pressure intervals chosen in this way, an especially broad pressure range can be made available advantageously.

The task of the present invention is also accomplished by an axial-piston engine with at least one working cylinder, which is fed from a continuously working combustion chamber that comprises a precombustion chamber and a main combustion chamber and that has an exhaust gas outlet, wherein the axial-piston engine is characterized by a precombustion chamber temperature sensor for determining a temperature in the precombustion chamber.

A temperature sensor of this sort delivers, in a simple manner, a meaningful value regarding the quality of the combustion or regarding the running stability of the axial-piston engine. Any sensor, for example a resistance temperature sensor, a thermocouple, an infrared sensor or the like, can be used as a temperature sensor.

Preferably, the precombustion chamber temperature sensor is designed or situated so that it determines the temperature of a flame in the precombustion chamber. This makes quite especially appropriately meaningful values possible.

The axial-piston engine can include in particular a combustion chamber regulating system, which includes the precombustion chamber temperature sensor as input sensor and regulates the combustion chamber so that the prechamber temperature is between 1,000° C. and 1,500° C. In this way it is possible, by means of a relatively simple and therefore dependable and very fast regulating circuit, to guarantee that the axial-piston engine produces extremely little pollutants. In particular, the danger that soot will be formed can be reduced to a minimum.

Furthermore, and in particular also independently of the other features of the present invention, cumulatively or alternatively to the above, the axial-piston engine can include an exhaust gas temperature sensor for determining the exhaust gas temperature.

By means of such an exhaust gas temperature sensor, the operating state of a continuously working combustion chamber can likewise be checked and regulated in a technically simple way. Such a regulating system ensures adequate and complete combustion of fuel, in particular in a simple way, so that the axial-piston engine exhibits optimal efficiency with minimum emission of pollutants.

By preference, the combustion chamber is regulated so that the exhaust gas temperature in an operating state, preferably when idling, is between 850° C. and 1,200° C. The latter can be done for example through the appropriate application of water and/or appropriate preheating of the combustible fuel, in particular of air, for example by controlling the water temperature or volume of water or else the proportion of air preheated or not preheated in a heat exchanger, in accordance with the aforementioned requirement.

According to another aspect of the invention, an axial-piston engine with a compressor stage comprising at least one cylinder, with an expander stage comprising at least one cylinder, and with at least one heat exchanger is proposed, wherein the heat-absorbing part of the heat exchanger is situated between the compressor stage and the combustion chamber and the heat-emitting part of the heat exchanger is situated between the expander stage and an environment, and wherein the axial-piston engine is characterized by the fact that the heat-absorbing and/or the heat-emitting part of the heat exchanger has, downstream and/or upstream, means for applying at least one fluid.

The application of a fluid into the stream of combustible fuel can contribute to an increase in the transfer capacity of the heat exchanger, for example since the specific heat capacity of the stream of combustible fuel can be adjusted to the specific heat capacity of the exhaust gas stream, through the application of a suitable fluid, or else can be increased beyond the specific heat capacity of the exhaust gas stream. The transfer of heat from the exhaust gas stream to the combustible fuel stream influenced thereby, for example advantageously, contributes to the ability of a higher quantity of heat to be coupled into the combustible fuel stream and thus into the working cycle while the construction size of the heat exchanger remains the same, whereby the thermodynamic efficiency can be increased. Alternatively or cumulatively, a fluid can also be applied to the exhaust gas stream. The applied fluid in this case can be for example a necessary aid for a downline exhaust gas post-treatment, which can be mixed ideally with the exhaust gas stream by a turbulent flow formed in the heat exchanger, so that a downline exhaust gas post-treatment system can thus be operated with maximum efficiency.

“Downstream” designates in this case the side of the heat exchanger from which the particular fluid emerges, or that part of the exhaust gas line or of the pipework carrying the combustible fuel into which the fluid enters after leaving the heat exchanger.

By analogy to this, “upstream” designates the side of the heat exchanger into which the particular fluid enters, or that part of the exhaust gas line or of the pipework carrying the combustible fuel from which the fluid enters into the heat exchanger.

In this respect, it does not matter whether the application of the fluid takes place immediately in the near spatial vicinity of the heat exchanger, or whether the application of the fluid takes place at a greater spatial distance.

Water and/or combustible substance for example can be applied appropriately as fluid. This has the advantage that the combustible fuel stream has on the one hand the previously described advantages of an increased specific heat capacity through the application of water and/or combustible substance, and on the other hand that the mixture can be prepared already in the heat exchanger or ahead of the combustion chamber and the combustion can take place in the combustion chamber with a combustion air ratio of the greatest possible local homogeneity. This also has in particular the advantage that the combustion behavior is marked only very slightly or not at all with efficiency-degrading, incomplete combustion.

For another configuration of an axial-piston engine, it is proposed that a water trap be situated in the heat-emitting part of the heat exchanger or downstream from the heat-emitting part of the heat exchanger. Because of the reduced temperature existing at the heat exchanger, vaporous water could condense out and damage the subsequent exhaust gas line by corrosion. Damage to the exhaust gas line can be reduced advantageously through this measure.

In addition, a method for operating an axial-piston engine with a compressor stage comprising at least one cylinder, with an expander stage comprising at least one cylinder, with at least one combustion chamber between the compressor stage and the expander stage and with at least one heat exchanger is proposed, wherein the heat-absorbing part of the heat exchanger is situated between the compressor stage and the combustion chamber and the heat-emitting part of the heat exchanger is situated between the expander stage and an environment, and wherein the method is characterized by the fact that at least one fluid is applied to the combustible fuel stream flowing through the heat exchanger and/or to the exhaust gas stream flowing through the heat exchanger. It is hereby possible—as already shown above—to improve the efficiency-enhancing transfer of heat from an exhaust gas stream being conducted into an environment into a combustible fuel stream, by increasing the specific heat capacity of the combustible fuel stream through the application of a fluid, and thus also increasing the flow of heat to the combustible fuel stream. The regenerative coupling of an energy stream into the working cycle of the axial-piston engine in this case can in turn bring about an increase in efficiency, in particular an increase in the thermodynamic efficiency, when the process is carried out appropriately.

Advantageously, the axial-piston engine is operated in such a way that water and/or combustible substance are applied. The result of this procedure is that the efficiency in turn, in particular the efficiency of the combustion process, can be increased through ideal mixing in the heat exchanger and ahead of the combustion chamber.

Combustible substance can likewise be applied to the exhaust gas flow, if this is expedient for example for an exhaust gas aftertreatment, so that the exhaust gas temperature can be further increased in the heat exchanger or after the heat exchanger. If necessary, postcombustion, which aftertreats the exhaust gas in an advantageous manner and minimizes pollutants, can also be carried out in this way. Heat released in the heat-emitting part of the heat exchanger could thus also be used indirectly for further warming of the combustible fuel stream, so that the efficiency of the axial-piston engine is hardly influenced negatively thereby.

In order to further implement this advantage, the fluid can be applied downstream and/or upstream from the heat exchanger.

Cumulatively or alternatively to this, separated water can be applied back into the combustible fuel stream and/or the exhaust gas stream. In the most favorable case, a closed water circuit is thereby realized, to which no additional water needs to be supplied from outside. Thus an additional advantage arises from the fact that a vehicle equipped with an axial-piston engine of this construction does not have to be refilled with water, in particular not with distilled water.

Advantageously, the application of water and/or combustible substance is stopped at a defined point in time before the axial-piston engine comes to a standstill, and the axial-piston engine is operated until it comes to a stop without an application of water and/or combustible substance. The water, possibly harmful for an exhaust gas line, which can be deposited in the exhaust gas line, in particular when the latter cools, can be avoided by this method. Advantageously, any water is also removed from the axial-piston engine itself before the axial-piston engine comes to a stop, so that damage to components of the axial-piston engine by water or water vapor, especially during the stoppage, is not promoted.

The task of the present invention is cumulatively or alternatively to the aforementioned features by an axial-piston engine with at least one compressor cylinder, with at least one working cylinder and with at least one pressure line, through which compressed combustible fuel is conducted from the compressor cylinder to the working cylinder, wherein the axial-piston engine is characterized by the fact that water or water vapor is applied to the compressor cylinder during an intake stroke of a compressor piston situated in the compressor cylinder.

On the one hand, this ensures excellent distribution of the water in the combustible fuel. On the other hand, the compression enthalpy modified by the water can be introduced non-critically into the combustible fuel, without the energy balance of the entire axial-piston engine being influenced too disadvantageously by the application of water. In particular, the compression process of an isothermal compression can be approximated thereby, whereby the energy balance can be optimized during the compression. The proportion of water—depending on the concrete implementation and also in combination with the application of water explained above in connection with a heat exchanger—can be used supplementally to regulate the temperature in the combustion chamber, and/or also to reduce pollution by means of chemical or catalytic reactions of the water.

The application of water can be done for example, depending on the concrete implementation of the present invention, by a metering pump. A metering pump can be dispensed with by means of a check valve, since then the compressor piston can also draw in water during its intake stroke through the check valve, which then closes during compression. The latter implementation is especially advantageous if a safety valve, for example a solenoid valve, is also provided in the water supply line in order to prevent leakage when the engine is stopped.

It is understood that water can possibly also be applied to the axial-piston engine even at a different place.

Additional advantages, objectives and properties of the present invention will be explained on the basis of the following description of the enclosed drawing, in which examples of various axial-piston engines and their assemblies are depicted.

The figures show the following:

FIG. 1 a schematic sectional view of a first axial-piston engine;

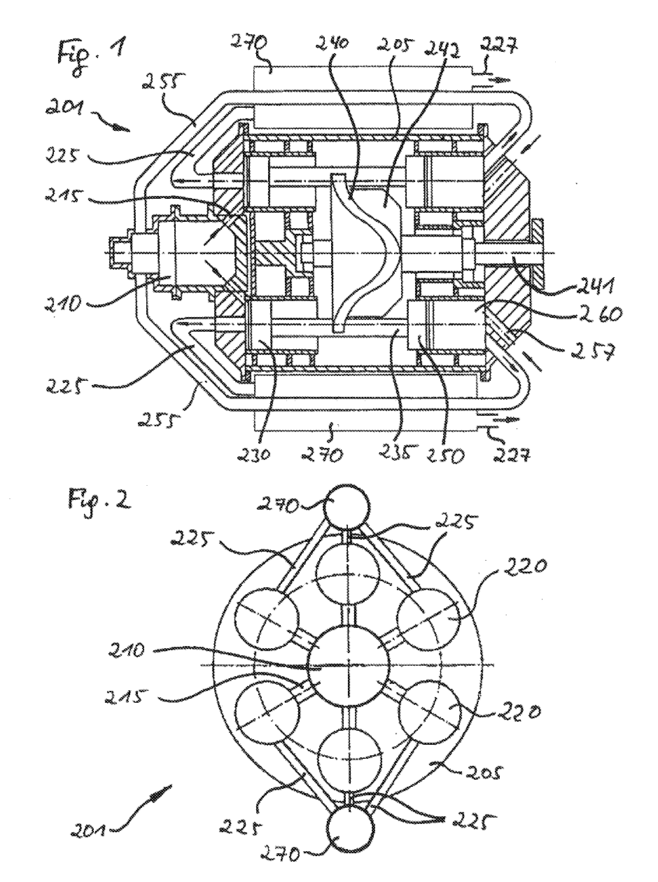

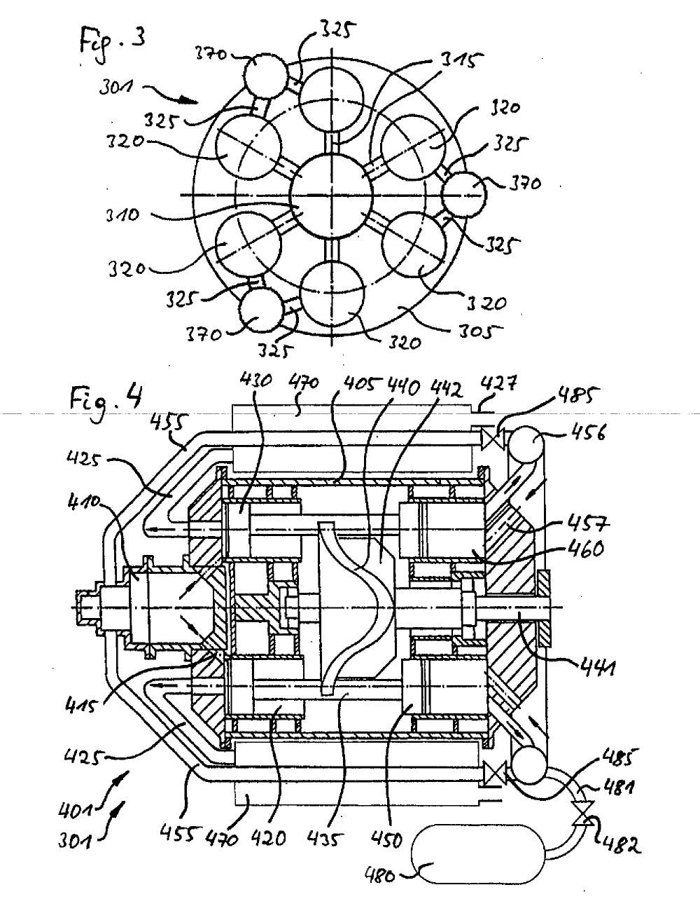

FIG. 2 a schematic top view of the axial-piston engine according to FIG. 1;

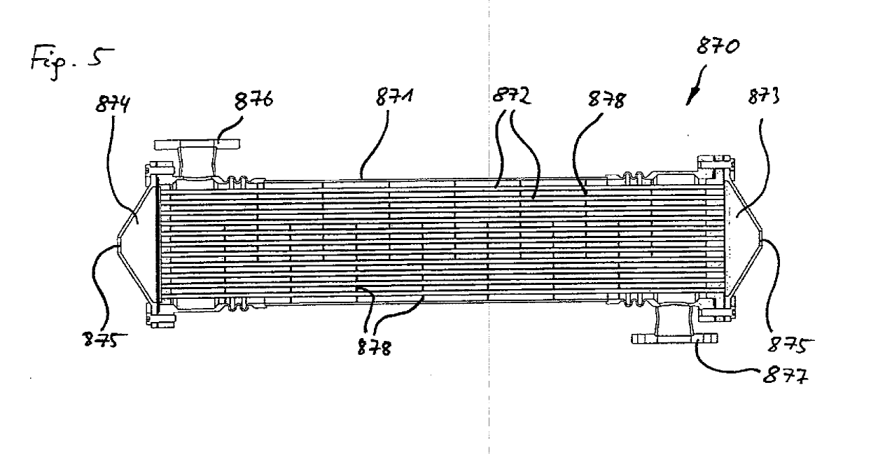

FIG. 3 a schematic top view of a second axial-piston engine, in a depiction similar to that in FIG. 2;

FIG. 4 a schematic sectional view of a third axial-piston engine, in a depiction similar to that in FIG. 1;

FIG. 5 a schematic sectional view of a heat exchanger;

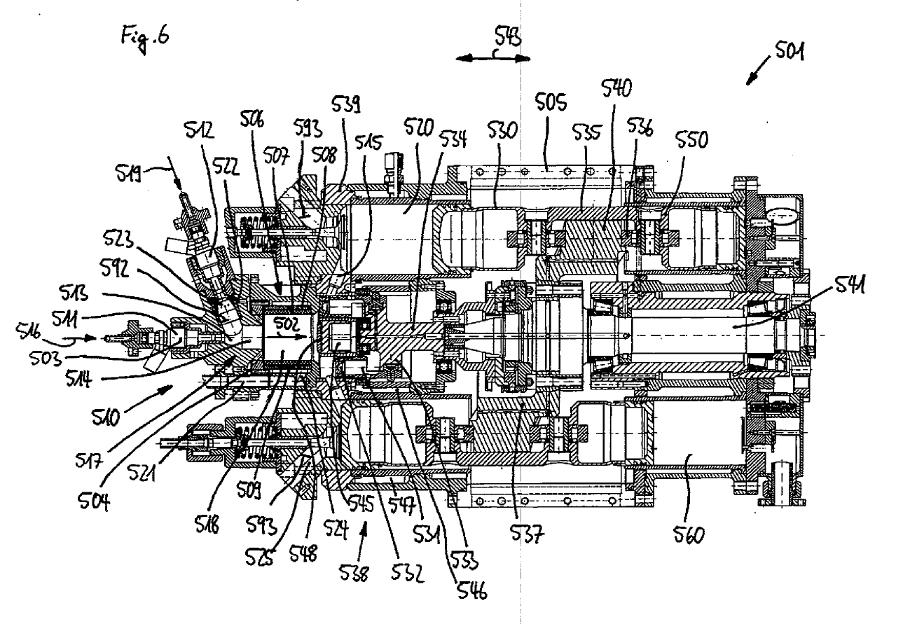

FIG. 6 a schematic sectional view of another axial-piston engine, with a precombustion chamber temperature sensor and two exhaust gas temperature sensors; and

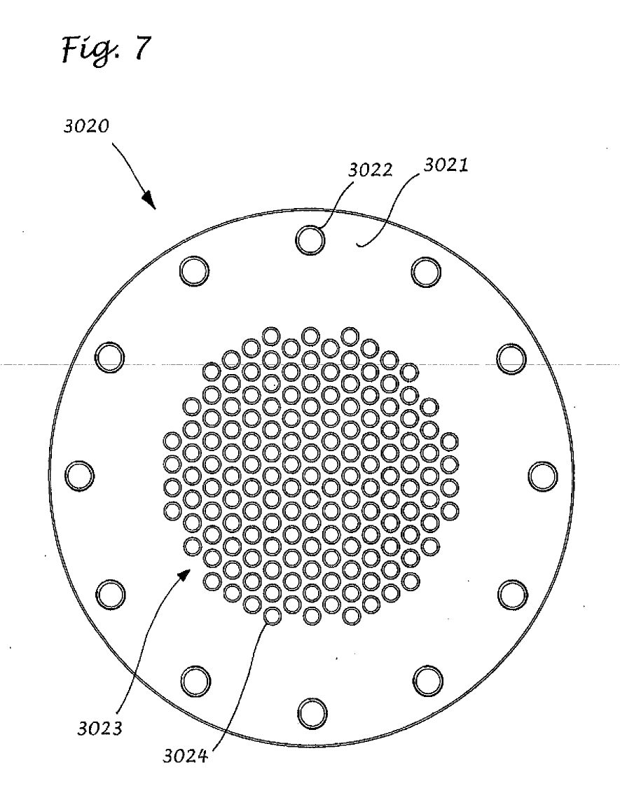

FIG. 7 a schematic depiction of a flange for a heat exchanger, with a matrix situated in it for accommodation of pipes of a heat exchanger.

Axial-piston engine 201 depicted in FIGS. 1 and 2 has a continuously working combustion chamber 210, from which working medium is fed successively via shot channels 215 (numbered as an example) to working cylinders 220 (numbered as an example). Situated in each of the working cylinders 220 are working pistons 230 (numbered as an example), which are connected on the one hand by way of a straight connecting rod 235 to an output, which is realized in this exemplary embodiment as a spacer 242 carrying a curved track 240, situated on an output shaft 241, and are connected on the other hand to a compressor piston 250, each of which runs in the compressor cylinder 260 in a manner explained in greater detail below.

After the working medium has performed its work in the working cylinder 220 and has placed a load on the working piston 230 accordingly, the working medium is expelled from working cylinder 220 through exhaust gas channels 225. Provided on the exhaust gas channels 225 are temperature sensors, not shown, which measure the temperature of the exhaust gas.

The exhaust gas channels 225 discharge into heat exchangers 270, in each instance, and subsequently leave the axial-piston engine 201 at appropriate outlets 227 in a known manner. The outlets 227 for their part can be connected again in particular to an annular duct, not shown, so that in the end the exhaust gas leaves the engine 201 at only one or two places. Depending on the concrete configuration in particular of the heat exchanger 270, a sound damper can possibly also be dispensed with, since the heat exchangers 270 themselves already have a sound-damping effect.

The heat exchangers 270 serve to preheat combustible fuel which is compressed in the compressor cylinders 260 by the compressor pistons 250 and conducted through a pressure line 255 to the combustion chamber 210. The compression takes place in this case in a known manner, by the fact that supply air is drawn in through supply lines 257 (numbered as an example) by the compressor pistons 250 and compressed in the compressor cylinders 260. Known and readily appropriately utilizable valve systems are used to this end.

As is directly apparent from FIG. 2, the axial-piston engine 201 has two heat exchangers 270, both of which are situated axially in reference to the axial-piston engine 201. Through this arrangement, the paths which the exhaust gas must traverse through the exhaust gas channels 225, in each instance to the heat exchangers 270 can be reduced significantly, compared to state-of-the-art axial-piston engines. The result of this is that in the end the exhaust gas reaches the respective heat exchanger 270 at a significantly higher temperature, so that in the end the combustible fuel can also be preheated to correspondingly higher temperatures. In practice, it has been found that at least 20% of fuel can be saved through such a configuration. It is assumed in this connection that savings of up to 30% or more are even possible by means of an optimized design.

Furthermore, the heat exchangers 270 are insulated with a thermal insulation of asbestos substitute, not shown here. This ensures that with this exemplary embodiment the external temperature of the axial-piston engine does not exceed 450° C. in the vicinity of the heat exchanger 270 under nearly all operating conditions. The only exceptions are overload situations, which occur only briefly anyway. In this case, the thermal insulation is designed to ensure a temperature gradient of 350° C. at the hottest place of the heat exchanger.

In this connection it is understood that the efficiency of the axial-piston engine 201 can be increased through additional measures. For example, the combustible fuel can be used in a known manner to cool or thermally insulate the combustion chamber 210, whereby its temperature can be increased still further before it enters the combustion chamber 210. Let it be emphasized here that the corresponding tempering can be limited on the one hand only to components of the combustible fuel, as is the case in the present exemplary embodiment in reference to combustion air. It is also conceivable to apply water to the combustion air already before or during the compression; this is also readily possible afterwards, however, for example in the pressure line 255.

Especially preferably, the application of water to the compressor cylinder 260 takes place during an intake stroke of the corresponding compressor piston 250, which results in isothermal compression, or compression as close as possible to isothermal compression. As is directly apparent, each working cycle of the compressor piston 250 comprises an intake stroke and a compression stroke, wherein during the intake stroke combustible fuel enters the compressor cylinder 260, which is then compressed, i.e., compressed, during the compression stroke, and conveyed into the pressure line 255. By applying water during the intake stroke, a uniform distribution of the water can be ensured in an operationally simple manner.

It is likewise conceivable to temper the fuel accordingly, wherein this is not absolutely necessary, since the quantity of fuel is usually relatively small in relation to the combustion air, and thus can be brought to high temperatures very quickly.

The axial-piston engine 301 depicted in FIG. 3 corresponds in its construction and in its manner of functioning essentially to the axial-piston engine 201 according to FIGS. 1 and 2. For this reason we will dispense with a detailed description, wherein assemblies in FIG. 3 that work similarly are also provided with similar reference labels and differ from one another only in the first digit. The axial-piston engine 301 also has a central combustion chamber 310, from which working medium in the working cylinder 320 can be conducted via shot channels 315 (numbered as an example) according to the working sequence of the axial-piston engine 301. After the working medium has performed its work, it is fed via exhaust gas channels 325 to heat exchangers 370, in each instance.

In this case the axial-piston engine 301, in contrast to the axial-piston engine 201, has one heat exchanger 370 each for exactly two working cylinders 320, whereby the length of the channels 325 can be reduced to a minimum. As is directly apparent, in this exemplary embodiment the heat exchangers 370 are partially inserted into the housing body 305 of the axial-piston engine 301, which leads to an even more compact construction than the construction of the axial-piston engine 201 according to FIGS. 1 and 2 in this case, the measure of how far the heat exchangers 370 can be inserted into the housing body 305 is limited by the possibility of the arrangement of other assemblies, such as, for example, a water cooling system for the working cylinders 220.

The axial-piston engine 401 depicted in FIG. 4 also corresponds essentially to the axial-piston engines 201 and 301 according to FIGS. 1 through 3. Accordingly, identically or similarly working assemblies are also labeled similarly, and differ only in the first digit. Accordingly, in other respects a detailed explanation of the mode of operation will also be dispensed with for this exemplary embodiment, since that was already done in reference to the axial-piston engine 201 according to FIGS. 1 and 2.

The axial-piston engine 401 also includes a housing body 405, on which a continuously working combustion chamber 410, six working cylinders 420 and six compressor cylinders 460 are provided. In this case the combustion chamber 410 is connected via shot channels 415 to the working cylinders 420, in each instance, so that working medium can be fed to the working cylinders 420 corresponding to the timing rate of the axial-piston engine 401.

After its work is done, the working medium leaves the working cylinders 420 through exhaust gas channels 425, which lead to heat exchangers 470, in each instance, wherein these heat exchangers 470 are arranged identically to the heat exchangers 270 of the axial-piston engine 201 according to FIGS. 1 and 2 (see in particular FIG. 2). The working medium leaves the heat exchangers 470 through outlets 427 (numbered as an example).

Situated in the working cylinders 420 and the compressor cylinders 460 are working pistons 430 and compressor pistons 450, respectively, which are connected with one another by means of a rigid connecting rod 435. The connecting rod 435 includes in a known manner a curved track 440, which is provided on a spacer 424, which ultimately drives an output shaft 441.

In this exemplary embodiment also, combustion air is drawn in through supply lines 457 and compressed in the compressor cylinders 460, in order to be applied via pressure lines 455 to the combustion chamber 410, whereby the measures named in the case of the aforementioned exemplary embodiment can likewise be provided, depending on the concrete implementation.

In addition, in the case of the axial-piston engine 401 the pressure lines 455 are connected with one another via an annular duct 456, whereby a uniform pressure in all pressure lines 455 can be guaranteed in a known manner. Between the annular duct 456 and each of the pressure lines 455 valves 485 are provided, whereby the supply of combustible fuel can be regulated or set by the pressure lines 455. Furthermore, a combustible fuel reservoir 480 is connected to the annular duct 456 via a reservoir line 481, in which a valve 482 is likewise situated.

The valves 482 and 485 can be opened or closed, depending on the operating state of the axial-piston engine 401. Thus it is conceivable, for example, to close one of the valves 485 when the axial-piston engine 401 needs less combustible fuel. It is also conceivable to partially close all valves 485 in such operating situations, and to allow them to operate as throttles. The surplus of combustible fuel can then be fed to the combustible fuel reservoir 480 when valve 482 is open. The latter is also possible in particular when the axial-piston engine 401 is running under deceleration, i.e., when no combustible fuel at all is needed, but rather it is being driven via the output shaft 441. The surplus of combustible fuel caused by the movement of the compressor pistons 450 that occurs in such an operating situation can likewise readily be stored in the combustible fuel reservoir 480.

The combustible fuel stored in this way can be fed supplementally to the axial-piston engine 401 as needed, i.e., in particular in driving off or acceleration situations, as well as for starting, so that a surplus of combustible fuel is provided without additional or more rapid movements of the compressor pistons 450.

The valves 482 and 485 can also be dispensed with, if appropriate, to guarantee the latter. Foregoing such valves for prolonged storage of compressed combustible fuel seems little suited, due to unavoidable leakage.

In an alternative embodiment to the axial-piston engine 401, the annular duct 456 can be dispensed with, wherein the outlets of the compressor cylinders 460 are then combined corresponding to the number of pressure lines 455—possibly by means of a section of annular duct. With a design of this sort it may possibly make sense to connect only one of the pressure lines 455, or not all pressure lines 455 to the combustible fuel reservoir 480, or to not provide them as connectible. Such a design indeed means that not all compression pistons 450 can fill the combustible fuel reservoir 480 during deceleration. On the other hand, sufficient combustible fuel is then available to the combustion chamber 410 so that combustion can be maintained without additional regulation or control system measures. Simultaneously with this, the combustible fuel reservoir 480 is filled by means of the other compressor pistons 450, so that combustible fuel is stockpiled accordingly and is available immediately, in particular for starting, driving off or acceleration phases.

It is understood that the axial-piston engine 401, in a different design variant not shown explicitly here, can be equipped with two combustible fuel reservoirs 480, wherein the two combustible fuel reservoirs 480 can then also be charged with different pressures, so that it is always possible with the two combustible fuel reservoirs 480 to work with different pressure intervals in real time. Preferably a pressure regulating system is provided in this case, which sets a first lower pressure limit and a first upper pressure limit for the first combustible fuel reservoir 480, and a second lower pressure limit and a second upper pressure limit for the second combustible fuel reservoir (not shown here), within which each combustible fuel reservoir 480 is charged with pressures, wherein the first upper pressure limit is below the second upper pressure limit and the first lower pressure limit is below the second lower pressure limit. Specifically, the first upper pressure limit can be set lower than or equal to the second lower pressure limit.

The heat exchanger 870 depicted in FIG. 5 can be used for example as heat exchangers 270, 370 and 470. This heat exchanger 870 has a plurality of small ducts 872 (numbered as an example) arranged axially in an exhaust gas space 871, which are connected to a supply air space 873 and an exhaust air space 874 in a way that is gas-tight with respect to the exhaust gas space 871. The heat exchanger 870 can be brought into the pressure lines 255, 455 of the aforementioned axial-piston engines 201, 301, 401 by way of openings 875, so that compressed combustible fuel can flow through the heat exchanger 870 via the small ducts 872. Furthermore, the exhaust gas space 871 has an exhaust gas inlet 876 and an exhaust gas outlet 877, wherein intimate contact of the exhaust gas with the small ducts 872 is promoted by means of deflector plates 878 that are arranged in a staggered pattern in the exhaust gas space and are each connected to a part of the small tubes 872. Since the deflector plates 878 are also tempered correspondingly by the exhaust gas, the deflector plates 878 also lead to a corresponding coupling of thermal energy into the small tubes 872.

Each exhaust gas inlet 876 is connected to one of the exhaust gas channels 225, 325, 425 of the axial-piston engines 201, 301, 401, while the exhaust gas outlet 877 represents the outputs 227, 427 of the axial-piston engines 201, 301, 401. It is understood that the exhaust gas outlet 877 can be connected in a great variety of designs to an exhaust pipe or other assemblies, already known. Furthermore, it is understood that the axial-piston engines 201, 301, 401 can also be provided with other heat exchangers, depending on the concrete configuration. It is also understandable in particular that the heat exchangers 870, in particular also those of the axial-piston engines 301 and 401, can be insulated appropriately, even if the heat exchangers should be constructed differently than the heat exchangers 870, as described on the basis of the axial-piston engine 201.

Not shown in FIGS. 1 through 5 are temperature sensors for measuring the temperature of the exhaust gas or in the combustion chamber. For such temperature sensors, all temperature sensors can be considered which can operationally reliably measure temperatures between 800° C. and 1,100° C. In particular, if the combustion chamber comprises a precombustion chamber and a main combustion chamber, the temperature of the precombustion chamber can also be measured by means of such temperature sensors. In this respect, the axial-piston engines 201, 301 and 401 described above can each be regulated by means of the temperature sensors in such a way that the exhaust gas temperature when leaving the working cylinders 220, 320, 420 is approximately 900° C., and the temperature in the precombustion chamber—if present—is approximately 1,000° C.

In the case of the other axial-piston engine 501 shown according to the depiction in FIG. 6, such temperature sensors are present in the form of a prechamber temperature sensor 592 and two exhaust gas temperature sensors 593, and are depicted schematically accordingly. In particular by means of the prechamber temperature sensor 592—which in this exemplary embodiment can also be referred to as preburner temperature sensor 592, due to its proximity to a preburner 517 of the other axial-piston engine 501—a meaningful value concerning the quality of combustion or with regard to the running stability of the other axial-piston engine 501 is ascertained. For example, a flame temperature can be measured in the prechamber 517, in order to be able to regulate different operating states in the other axial-piston engine 501 by means of a combustion chamber regulating system. By means of the exhaust gas temperature sensors 593, which are positioned at outlets or exhaust gas channels 525 of the respective working cylinder 520, specifically the operating state of the combustion chamber 510 can be checked cumulatively and regulated if necessary, so that optimal combustion of the combustible fuels is always ensured.

Otherwise, the construction and operating principle of the other axial-piston engine 501 correspond to those of the previously described axial-piston engines. In this respect, the other axial-piston engine 501 has a housing body 505, on which a continuously working combustion chamber 510, six working cylinders 520 and six compressor cylinders 560 are provided.

Inside the combustion chamber 510, combustible fuels can be both ignited and burned, wherein the combustion chamber 510 can be charged with combustible fuels in the manner described above. Advantageously, the other axial-piston engine 501 works with a two-stage combustion system, to which end the combustion chamber 510 has the previously already mentioned preburner 517 and a main burner 518. Combustible fuels can be injected into the preburner 517 and into the main burner 518, wherein a proportion of combustion air of the axial-piston engine 501, which specifically in this exemplary embodiment can be smaller than 15% of the total combustion air, can also be introduced in particular into the prechamber 517.

The preburner 517 has a smaller diameter than the main burner 518, wherein the combustion chamber 510 has a transition area that comprises a conical chamber 513 and a cylindrical chamber 514.

To supply combustible fuels and combustion air, on the one hand a main nozzle 511 and on the other hand a processing nozzle 512 discharge into the combustion chamber 510, in particular into the associated conical chamber 513. By means of the main nozzle 511 and the processing nozzle 512, combustible fuels or combustible substance can be injected into the combustion chambers 510, wherein in this exemplary embodiment the combustible fuels injected by means of the processing nozzle 512 are already being mixed or are already mixed with combustion air.

The main nozzle 511 is oriented essentially parallel to a main combustion direction 502 of the combustion chamber 510. Furthermore, the main nozzle 511 is oriented coaxially to an axis of symmetry 503 of the combustion chamber 510, wherein the axis of symmetry 503 lies parallel to the main combustion direction 502.

Furthermore, the processing nozzle 512 is situated at an angle (not sketched in explicitly here for the sake of clarity) with respect to the main nozzle 511, so that a jet direction 516 of the main nozzle 511 and a jet direction 519 of the processing nozzle 512 intersect at a mutual point of intersection within the conical chamber 513.

Combustible substance or fuel is injected from the main nozzle 511 into the main burner 518 in this exemplary embodiment without additional air supply, wherein the combustible substance can already be preheated and ideally thermally decomposed in the main burner 518. To this end, the volume of combustion air corresponding to the quantity of combustible substance flowing through the main nozzle 511 is introduced into a combustion space 526 behind the preburner 517 or the main burner 518, to which end a separate combustion air supply system 504 is provided, which discharges into the combustion space 526.

To this end, the separate precombustion air supply system 504 is connected to a process air supply 521, wherein another combustion air supply system 522 can be supplied with combustion air from the separate combustion air supply 504, which in this case supplies a perforated ring 523 with combustion air. The perforated ring 523 is assigned in this case to the processing nozzle 512. In this respect, the combustible substance injected with the processing nozzle 512, mixed additionally with process air, can be injected into the preburner 517 or into the conical chamber 513 of the main burner 518.

In addition, the combustion chamber 510, in particular the combustion space 526, includes a ceramic assembly 506, which is advantageously air-cooled. The ceramic assembly 506 includes in this case a ceramic combustion chamber wall 507, which in turn is surrounded by a profiled pipe 508. Around this profiled pipe 508 extends a cooling air chamber 509, which is connected to the process air supply system 521 by means of a cooling air chamber supply system 524.

The known working cylinders 520 carry corresponding working pistons 530, which are mechanically connected to compressor pistons 550 by means of connecting rods 535, in each instance.

In this exemplary embodiment the connecting rods 535 include connecting rod running wheels 536, which run along a curved track 540, while the working pistons 530 or the compressor pistons 550 are moved. An output shaft 541 is thereby set in rotation, which is connected to the curved track 540 by means of a driving curved track carrier 537. Power produced by the axial-piston engine 501 can be delivered via the output shaft 541.

In a known way, by means of the compressor pistons 550 compression of the process air occurs, also including injected water if appropriate, which can be used if necessary for additional cooling. If the application of water or of steam occurs during an intake stroke of the corresponding compressor piston 550, isothermal compression of the combustible fuel can specifically be promoted. An application of water that accompanies the intake stroke can ensure an especially uniform distribution of the water within the combustible fuel, in an operationally simple manner.

Exhaust gases can be cooled significantly more deeply thereby, if necessary, in one or more heat exchangers not depicted here (but see FIG. 5), if the process air is to be prewarmed by means of one or more such heat exchangers and carried to the combustion chamber 510 as combustible fuel, as described for example already in detail in the exemplary embodiments already explained above with regard to FIGS. 1 through 5. The exhaust gases can be fed to the heat exchanger or heat exchangers via the exhaust gas channels 525 named above, wherein the heat exchangers are arranged axially in reference to the other axial-piston engine 501.

In addition, the process air can be further prewarmed or heated through a contact with additional assemblies of the axial-piston engine 501 that must be cooled, as has also already been explained. The process air compressed and heated in this way is then applied to the combustion chamber 510 in the manner that has already been explained, whereby the efficiency of the other axial-piston engine 501 can be further increased.

Each of the working cylinders 520 of the axial-piston engine 501 is connected via a shot channel 515 to the combustion chamber 510, so that an ignited combustible fuel mixture or fuel-air mixture can pass out of the combustion chamber 510 via the shot channels 515 into the respective working cylinder 520 and can perform work on the working pistons 530 as a working medium.

In this respect, the working medium flowing from the combustion chamber 510 can be fed via at least one shot channel 515 successively to at least two working cylinders 520, wherein for each working cylinder 520 one shot channel 515 is provided, which can be closed and opened by means of a control piston 531. Thus the number of the control pistons 531 of the other axial-piston engine 501 is prescribed by the number of the working cylinders 520. Closing the shot channel 515 is done in this case by means of the control piston 531, including its control piston cover 532. The control piston 531 is driven by means of a control piston curved track 533, wherein a spacer 534 for the control piston curved track 533 to the drive shaft 541 is provided, which also serves in particular for thermal decoupling. In the present exemplary embodiment of the other axial-piston engine 501, the control piston 531 can perform an essentially axially directed stroke motion 543. To this end, each of the control pistons 531 is guided by means of sliders, not further labeled, which are supported in the control piston curved track 533, wherein the sliders each have a safety cam that runs back and forth in a guideway, not further labeled, and prevents the control piston 531 from turning.

Since the control piston 531 comes into contact in the area of the shot channel 515 with the hot working medium from the combustion chamber 510, it is advantageous if the control piston 531 is water-cooled. To this end, the other axial-piston engine 501 has a water cooling system 538, in particular in the area of the control piston 531, wherein the water cooling system 538 includes inner cooling ducts 545, middle cooling ducts 546 and outer cooling ducts 547. Well cooled in this way, the control piston 531 can be moved operationally reliably in a corresponding control piston cylinder.

The shot channels 515 and the control pistons 531 can be provided using especially simple construction, if the other axial piston engine 501 has a shot channel ring 539. In this case the shot channel ring 539 has a middle axis, around which in particular the parts of the working cylinders 520 and of the control piston cylinders are arranged concentrically. Between each working cylinder 520 and control piston cylinder a shot channel 515 is provided, wherein every shot channel 515 is spatially connected to a cutout (not labeled here) of a combustion chamber floor 548 of the combustion chamber 510. In this respect, the working medium can pass from the combustion chamber 510 via the shot channels 515 into the working cylinders 520 and there perform work, by means of which the compressor pistons 550 can also be moved. It is understood, that coatings and inserts can also be provided, depending on the concrete configuration, in order to protect in particular the shot channel ring 539 or its material from direct contact with corrosive combustion products or with excessively high temperatures.

It is understood that the other axial-piston engine 501 for example can likewise be equipped with at least one combustible fuel reservoir and corresponding valves, although this is not shown explicitly in the concrete exemplary embodiment according to FIG. 6.

In addition, in the case of the other axial-piston engine the combustible fuel reservoir can be provided in a double version, in order to be able to store compressed combustible fuels at different pressures. The two existing combustible fuel reservoirs can be connected in this case to corresponding pressure lines of the combustion chamber 510, wherein the combustible fuel reservoirs are fluid-connectible with or separable from the pressure lines by means of valves. Stop valves or throttle valves, or regulating or control valves, can be provided in particular between the working cylinders 520 or compressor cylinders 560 and the combustible fuel reservoir. For example, the aforementioned valves can be opened or closed appropriately during driving-off or acceleration situations, as well as for starting, whereby a surplus of combustible fuel can be made available to the combustion chamber 510, at least for a limited period of time. The combustible fuel reservoirs are interconnected fluidically preferably between one of the compressor cylinders and one of the heat exchangers. The two combustible fuel reservoirs are ideally operated at different pressures, in order thereby to be able to make very good use of the energy provided by the other axial-piston engine 501 in the form of pressure. To this end, the provided upper pressure limit and lower pressure limit at the first combustible fuel reservoir can be set by means of an appropriate pressure regulating system below the upper pressure limits and lower pressure limits of the second combustible fuel reservoir. It is understood that in this case work can be done on the combustible fuel reservoirs with different pressure intervals.

FIG. 7 shows a heat exchanger head plate 3020 which is suitable for use for a heat exchanger for an axial-piston engine, in particular for a heat exchanger according to FIG. 5. For the purpose of mounting on and connection to an output manifold of an axial-piston engine, the heat exchanger head plate 3020 includes a flange 3021 with corresponding bore holes 3022 arranged in a circle in the radially outer area of the heat exchanger head plate 3020. In the radially inner area of the flange 3021 is the matrix 3023, which has numerous bore holes designed as pipe seats 3024 for receiving pipes, such as for example the small pipes 872 from FIG. 7.

The entire heat exchanger head plate 3020 is preferably made from the same material from which the pipes or the small pipes 872 are also made, in order to ensure that the thermal expansion coefficient is as homogeneous as possible in the entire heat exchanger and that thermal stresses in the heat exchanger are thereby minimized. Cumulatively to this, the jacket housing of the heat exchanger can likewise be produced from a material that corresponds to the heat exchanger head plate 3020 or to the pipes. The pipe seats 3024 can be designed for example with a fit such that the pipes mounted in these pipe seats 3024 are inserted by means of a press fit.

Alternatively to this, the pipe seats 3024 can also be designed so that a clearance fit or a transition fit is realized. In this way, mounting of the pipes in the pipe seats 3024 can also take place by means of a materially bonded connection rather than a frictional connection. The material connection is preferably effected in this case by welding or soldering, wherein a material corresponding to the heat exchanger head plate 3020 or to the pipes is used as the soldering or welding material. This also has the advantage that thermal stresses in the pipe seats 3024 can be minimized by homogeneous thermal expansion coefficients.

It is also possible in the case of this accomplishment to install pipes in the pipe seats 3024 by press fit, and in addition to solder or weld them. Through this type of installation, leak tightness of the heat exchanger can also be ensured, if different materials are used for the pipes and the heat exchanger head plate 3020, since the possibility exists that due to the very high occurring temperatures of over 1000° C. use of only a press fit can fail under certain circumstances because of different thermal expansion coefficients.

Reference labels:

| | |
|---|---|
| 201 | axial piston engine |
| 205 | housing body |
| 210 | combustion chamber |
| 215 | shot channel |
| 220 | working cylinder |
| 225 | exhaust gas channel |
| 227 | outlet |
| 230 | working piston |
| 235 | connecting rod |
| 240 | curved track |
| 241 | output shaft |
| 242 | spacer |
| 250 | compressor piston |
| 255 | pressure line |
| 257 | supply line |
| 260 | compressor cylinder |
| 270 | heat exchanger |
| 301 | axial piston engine |
| 305 | housing body |
| 310 | combustion chamber |
| 315 | shot channel |
| 320 | working cylinder |
| 325 | exhaust gas channel |
| 370 | heat exchanger |
| 401 | axial piston engine |
| 405 | housing body |
| 410 | combustion chamber |
| 415 | shot channel |
| 420 | working cylinder |
| 425 | exhaust gas channel |
| 427 | outlet |
| 430 | working piston |
| 435 | connecting rod |
| 440 | curved track |
| 441 | output shaft |
| 442 | spacer |
| 450 | compressor piston |
| 455 | pressure line |
| 456 | annular duct |
| 457 | supply line |
| 460 | compressor cylinder |
| 470 | heat exchanger |
| 480 | combustible fuel reservoir |
| 481 | reservoir line |
| 485 | valve |
| 501 | axial-piston engine |
| 502 | main combustion direction |
| 503 | axis of symmetry |
| 504 | combustion air supply |
| 505 | housing body |
| 506 | ceramic assembly |
| 507 | ceramic combustion chamber |
| | wall |
| 508 | profiled pipe |
| 509 | cooling air chamber |
| 510 | combustion chamber |
| 511 | main nozzle |
| 512 | processing nozzle |
| 513 | conical chamber |
| 514 | cylindrical chamber |
| 515 | shot channel |
| 516 | first jet direction |
| 517 | preburner |
| 518 | main burner |
| 519 | other jet direction |
| 520 | working cylinder |
| 521 | process air supply |
| 522 | other combustion air supply |
| 523 | perforated ring |
| 524 | cooling air chamber supply |
| 525 | exhaust gas channel |
| 526 | combustion space |
| 530 | working piston |
| 531 | control piston |
| 532 | control piston cover |
| 533 | control piston curved track |
| 534 | spacer |
| 535 | connecting rod |
| 536 | connecting rod running wheels |
| 537 | driving curved track carrier |
| 538 | water cooling system |
| 539 | shot channel ring |
| 540 | curved track |
| 541 | output shaft |
| 543 | stroke motion |
| 545 | inner cooling ducts |
| 546 | middle cooling ducts |
| 547 | outer cooling ducts |
| 548 | combustion chamber floor |
| 550 | compressor piston |
| 560 | compressor cylinder |
| 592 | prechamber temperature |
| | sensor |
| 593 | exhaust gas temperature |
| | sensor |
| 870 | heat exchanger |
| 871 | exhaust gas space |
| 872 | small pipe |
| 873 | supply air space |
| 874 | exhaust air space |
| 875 | opening |
| 876 | exhaust gas input |
| 877 | exhaust gas output |
| 878 | deflector plates |
| 3200 | heat exchanger head plate |
| 3021 | flange |
| 3022 | mounting hole |
| 3023 | matrix |
| 3024 | pipe seat |

1-36. (canceled)

37. An axial-piston engine with a combustible fuel supply system and an exhaust gas removal system that are coupled with one another with heat transfer, comprising at least two heat exchangers.

38. The axial-piston engine according to claim 37, wherein the heat exchangers are arranged axially.

39. The axial-piston engine according to claim 37, comprising at least four pistons, wherein the exhaust gases from at least two adjacent pistons are conducted into one heat exchanger.

40. The axial-piston engine according to claim 37, wherein the exhaust gases from three pistons are conducted into a common heat exchanger.

41. An axial-piston engine with a combustible fuel supply system and an exhaust gas removal system that are coupled with one another with heat transfer, comprising at least one heat exchanger insulation system.

42. The axial-piston engine according to claim 41, wherein the heat exchanger insulation between the heat exchanger and the environment of the axial-piston engine allows a maximum temperature gradient of 400° C.

43. The axial-piston engine according to claim 41, wherein the exterior temperature of the axial-piston engine in the area of the heat exchanger insulation does not exceed 500° C.

44. An axial-piston engine with at least one compressor cylinder, with at least one working cylinder and with at least one pressure line, through which compressed combustible fuel is conducted from the compressor cylinder to the working cylinder, comprising a combustible fuel reservoir in which compressed medium can be stored temporarily.

45. The axial-piston engine according to claim 44, wherein the combustible fuel reservoir is provided between the compressor cylinder and a heat exchanger.

46. The axial-piston engine according to claim 44, wherein a valve is situated between the compressor cylinder and the combustible fuel reservoir.

47. The axial-piston engine according to claim 44, wherein a valve is situated between the combustible fuel reservoir and the working cylinder.

48. The axial-piston engine according to claim 44, comprising at least two combustible fuel reservoirs.

49. The axial-piston engine according to claim 48, wherein said at least two combustible fuel reservoirs are charged with different pressures.

50. The axial-piston engine according to claim 49, comprising a pressure regulating system that defines a first lower pressure limit and a first upper pressure limit for the first combustible fuel reservoir, and a second lower pressure limit and a second upper pressure limit for the second combustible fuel reservoir, within which a combustible fuel reservoir is pressurized, wherein the first upper pressure limit is lower than the second upper pressure limit and the first lower pressure limit is lower than the second lower pressure limit.

51. The axial-piston engine according to claim 50, wherein the first upper pressure limit is lower than or equal to the second lower pressure limit.

52. An axial-piston engine with at least one working cylinder that is fed from a continuously working combustion chamber that comprises a precombustion chamber and a main combustion chamber and which has an exhaust gas outlet, comprising a precombustion chamber temperature sensor for determination of the temperature in the precombustion chamber.

53. The axial-piston engine according to claim 52, wherein the precombustion chamber temperature sensor determines a flame temperature in the precombustion chamber.

54. The axial-piston engine according to claim 52, comprising a combustion chamber regulating system which includes the precombustion chamber temperature sensor as input sensor and regulates the combustion chamber so that the prechamber temperature is between 1,000° C. and 1500° C.

55. The axial-piston engine according to claim 52, comprising an exhaust gas temperature sensor for determination of the exhaust gas temperature.

56. The axial-piston engine according to claim 55, wherein the combustion chamber regulating system includes the exhaust gas temperature sensor as input sensor and regulates the combustion chamber in such a way that the exhaust gas temperature in an operating state, preferably in an idling operating state, is between 850° C. and 1,200° C.

57. The axial-piston engine according to claim 37, comprising internal continuous combustion (icc).

58. A method for production of a heat exchanger of an axial-piston engine that has a compressor stage comprising at least one cylinder and an expander stage comprising at least one cylinder, as well as at least one combustion chamber between the compressor stage and the expander stage, wherein the heat-absorbing part of the heat exchanger is situated between the compressor stage and the combustion chamber and the heat-emitting part of the heat exchanger is situated between the expander stage and an environment, and with at least one pipe wall dividing the heat-emitting part from the heat-absorbing part of the heat exchanger to separate two streams of material, wherein the pipe is situated in at least one matrix consisting of a material corresponding to the pipe, and is connected by material bonding and/or by friction to this matrix.

59. The method for production of a heat exchanger according to claim 58, wherein the material connection between the pipe and the matrix is made by welding or soldering.

60. The method for production of a heat exchanger according to claim 58, wherein the frictional bond between the pipe and the matrix is made by shrinking.
